(19) United States
(12) Patent Application Publication
(10) Pub. No.: US 2015/0054730 A1
(43) Pub. Date: Feb. 26, 2015

(54) WRISTBAND TYPE INFORMATION PROCESSING APPARATUS AND STORAGE MEDIUM

(71) Applicant: Sony Corporation, Minato-ku (JP)

(72) Inventor: Kenichiro KODAMA, Tokyo (JP)

(73) Assignee: Sony Corporation, Minato-ku (JP)

(21) Appl. No.: 14/325,801

(22) Filed: Jul. 8, 2014

(30) Foreign Application Priority Data
Aug. 23, 2013 (JP) 2013-173229

(51) Int. Cl. G09G 3/00; G06F 3/01; G09G 5/00

(52) U.S. Cl. CPC G09G 3/001; G09G 5/006; G06F 3/017; G06F 3/013; G09G 2354/00; G09G 2320/068; H04M 1/6041
USPC 345/156; 345/520

(57) ABSTRACT

There is provided a wristband type information processing apparatus including a band unit configured to be worn on a wrist of a user, a projection unit configured to project an image on a hand wearing the band unit, and a control unit configured to control the projection unit in a manner that at least one of an image that is stored in a storage unit and an image that is input from an external apparatus is projected on the hand.

### CROSS REFERENCE TO RELATED APPLICATIONS

This application claims the benefit of Japanese Priority Patent Application JP 2013-173229 filed Aug. 23, 2013, the entire contents of which are incorporated herein by reference.

### BACKGROUND

The present disclosure relates to a wristband type information processing apparatus and a storage medium.

In recent years, techniques for improving the usability of mobile terminals have been developed as mobile terminals are becoming more and more common and having higher performance.

For example, US 2011-0133934A discloses a technique to project an image on a forearm portion of a user by placing a projector on an upper arm portion and also to allocate each key to each part of a body on which the image is projected so that an associated device can be operated by a touch or a flick operation on those parts.

### SUMMARY

With the technique disclosed in US 2011-0133934A, however, it takes time for the user to wind up a device around the upper arm portion, and the usability is expected to be further improved.

Accordingly, the present disclosure proposes a novel and improved wristband type information processing apparatus and storage medium which can improve the usability of a mobile terminal.

According to an embodiment of the present disclosure, there is provided a wristband type information processing apparatus including a band unit configured to be worn on a wrist of a user, a projection unit configured to project an image on a hand wearing the band unit, and a control unit configured to control the projection unit in a manner that at least one of an image that is stored in a storage unit and an image that is input from an external apparatus is projected on the hand.

According to another embodiment of the present disclosure, there is provided a non-transitory computer-readable storage medium having a program stored therein, the program for causing a computer to function as a projection unit configured to project an image on a hand wearing a band unit, and a control unit configured to control the projection unit in a manner that at least one of an image stored in a storage unit and an image input from an external apparatus is projected on the hand.

As described above, according to one or more of embodiments of the present disclosure, the usability of a mobile terminal can be improved. Note that the effects described above are not necessarily limited, and in addition to or instead of the effects described above, any of the effects that are described in this specification or other effects that can be obtained from this specification may be produced.

### BRIEF DESCRIPTION OF THE DRAWINGS

FIG. 1 is an explanatory drawing showing an overview of a projection system according to an embodiment of the present disclosure;

FIG. 2 is a block diagram showing a configuration of a projection system according to an embodiment of the present disclosure;

FIG. 3 is a sequence diagram showing an operation of a projection system according to an embodiment of the present disclosure;

FIGS. 4A to 4C are explanatory drawings showing projection processing according to a first embodiment;

FIGS. 5A to 5C are explanatory drawings showing projection processing according to a second embodiment;

FIGS. 6A and 6B are explanatory drawings showing projection processing according to a third embodiment;

FIGS. 7A and 7B are explanatory drawings showing projection processing according to a fourth embodiment;

FIGS. 8A to 8C are explanatory drawings showing projection processing according to a fifth embodiment;

FIGS. 9A to 9C are explanatory drawings showing projection processing according to a sixth embodiment;

FIGS. 10A and 10B are explanatory drawings showing projection processing according to a seventh embodiment;

FIG. 11 is an explanatory drawing showing projection processing according to a seventh embodiment;

FIGS. 12A and 12B are explanatory drawings showing projection processing according to an eighth embodiment;

FIGS. 13A and 13B are explanatory drawings showing projection processing according to a ninth embodiment; and

FIG. 14 is a block diagram showing a configuration of a wristband type terminal according to a tenth embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order.

1. Overview of a projection system according to an embodiment of the present disclosure

2. Embodiments
2-1. Common form
   2-1-1. Configuration
   2-1-2. Operation processing
2-2. First embodiment
2-3. Second embodiment
2-4. Third embodiment
2-5. Fourth embodiment
2-6. Fifth embodiment
2-7. Sixth embodiment
2-8. Seventh embodiment
2-9. Eighth embodiment
2-10. Ninth embodiment
2-11. Tenth embodiment

3. Conclusion

### 1. OVERVIEW OF A PROJECTION SYSTEM ACCORDING TO AN EMBODIMENT OF THE PRESENT DISCLOSURE

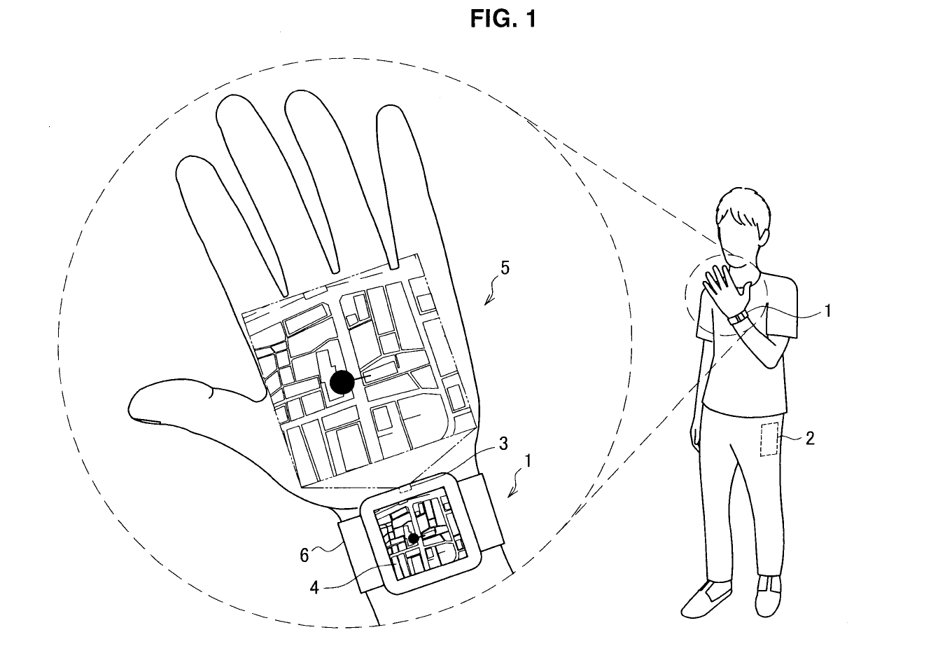

First, an overview of a projection system according to an embodiment of the present disclosure will be described with reference to FIG. 1.

FIG. 1 is an explanatory drawing showing the overview of the projection system according to an embodiment of the present disclosure. As shown in FIG. 1, the projection system according to an embodiment of the present disclosure includes a wristband type terminal 1 (wristband type information processing apparatus) and a smartphone 2 (external apparatus).

As shown in FIG. 1, the wristband type terminal 1 is worn on a wrist of a user by use of a band unit 6. The band unit 6 is formed in a manner similar to that of a band for wristwatch made of leather, metal, fiber, rubber, or the like. Note that in the wristband type terminal 1, a portion other than the band unit 6, the portion being provided with a projector 3, a display unit 4, and the like, is also called a main body.

The wristband type terminal 1 is connected to the smartphone 2 by wireless communication, and an image received from the smartphone 2 in a pocket is displayed on the display unit 4. Further, the wristband type terminal 1 projects the image received from the smartphone 2 on a hand wearing the band unit 6, by use of the projector 3 (projection unit). In an example shown in FIG. 1, the wristband type terminal 1 projects, as a projected image 5, a map image generated by use of a global positioning system (GPS) function in the smartphone 2.

The size of the wristband type terminal 1 is limited to an extent of a size of a common wristwatch, for example, in order to be carried with. Accordingly, there is a limitation on the physical size of the display unit 4, and as shown in FIG. 1, it may be difficult for the user to see the map displayed on the display unit 4, for example. Accordingly, the wristband type terminal 1 according to this embodiment projects, on the hand, an enlarged image having substantially the same inch size as an image on the smartphone 2, for example, by use of the projector 3, thereby improving the visibility of the image. This enables the user to check the position of the user on the map or find the destination easily by use of the projected image 5 having substantially the same size as the image on the smartphone 2.

Further, the user does not have to take out the smartphone 2 and can leave the smartphone 2 in the pocket or a bag to view the image such as the map. Thus, the wristband type terminal 1 can spare the user the trouble of taking out the smartphone 2 of the pocket or the bag.

Here, with the technique disclosed in US 2011-0133934A, the user takes time to wind up the device on the upper arm portion. Further, in the technique disclosed in US 2011-0133934A, since it is assumed that the image is projected on the skin, the user is expected to use the device when wearing such clothes that do not cover the arm. That is, unfortunately, the user has inconvenience in using the technique disclosed in US 2011-0133934A.

Accordingly, focusing on such circumstances, the wristband type information processing apparatus according to an embodiment of the present disclosure is made. The wristband type information processing apparatus according to an embodiment of the present disclosure can improve the usability of the mobile terminal.

More specifically, since the wristband type terminal 1 is worn on the wrist of the user, the user does not have to wind up the apparatus on the upper arm portion, or can use the apparatus even when wearing such clothes that cover the arm, like one with long sleeves. Furthermore, since the user is accustomed to wear something on the wrist like a wristwatch, a wristband, or a bracelet, the user can use the wristband type terminal 1 without any unnatural feeling.

Further, as shown in FIG. 1, the wristband type terminal 1 is about a size of a wristwatch. Generally speaking, since a wristwatch is lighter than a smartphone, the user can operate the wristband type terminal 1 with less labor and the hand is less tired than the smartphone 2 by actually taking the smartphone 2 on the hand.

Furthermore, by wearing the wristband type terminal 1 in a manner that the projector 3 is placed on the inner surface of the wrist, as shown in FIG. 1, the user can cause the projected image 5 to be projected by using the palm as a plane of projection. In this case, the projected image 5 can be hidden from people or objects around the user, which increases privacy. Further, in a case where the image is projected on the palm, the user places the palm toward the user in order to view the image. In a case where the user operates the smartphone 2 by holding the smartphone 2, usually, the palm is placed toward the user. Therefore, the operability of the wristband type terminal 1 is similar to that of the smartphone 2. Accordingly, the user can use the wristband type terminal 1 without unnatural feeling.

Further, the image projected by the projector 3 is an image showing a graphical user interface (GUI) of the smartphone 2, and the user can input an operation on the projected image to the wristband type terminal 1. That is, the wristband type terminal 1 functions as an output apparatus and an input apparatus of the smartphone 2. Accordingly, the user can operate the smartphone 2 without taking out the smartphone 2 of the pocket or the bag. Thus, the usability of the smartphone 2 is further improved.

The overview of the projection system according to an embodiment of the present disclosure has been described above. Next, projection systems according to embodiments of the present disclosure will be described in detail.

### 2. EMBODIMENTS

### 2-1. Common Form

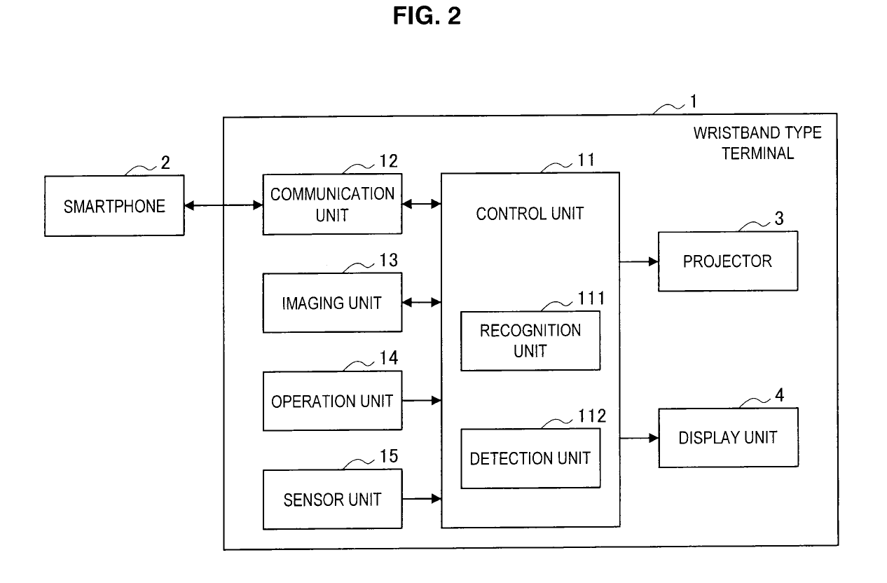

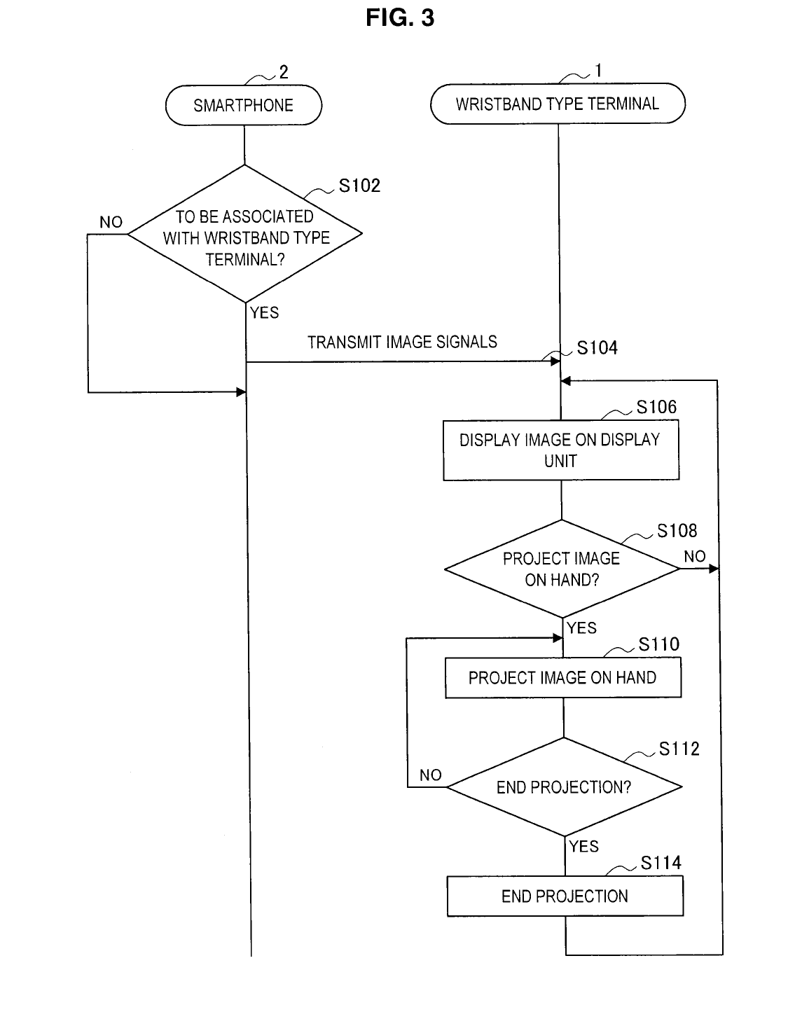

First, a configuration and operation processing of a projection system, which are common to embodiments of the present disclosure, will be described with reference to FIG. 2 and FIG. 3.

### [2-1-1. Configuration]

FIG. 2 is a block diagram showing a configuration of a projection system according to an embodiment of the present disclosure. As shown in FIG. 2, the wristband type terminal 1 includes the projector 3, the display unit 4, a control unit 11, a communication unit 12, an imaging unit 13, an operation unit 14, and a sensor unit 15, and is operated in association with the smartphone 2.

### (Smartphone 2)

The smartphone 2 is an information processing apparatus that is operated independently of or in association with the wristband type terminal 1. In a case of the operation in association with the wristband type terminal 1, the smartphone 2 causes the wristband type terminal 1 to function as an output apparatus and an input apparatus. That is, the smartphone 2 has a function of transmitting an image that is to be projected or displayed and receiving information indicating a user's operation. More specifically, the smartphone 2 transmits an image inducing a GUI to the wristband type terminal 1, and receives a user's operation in response to the GUI. Then, the smartphone 2 executes processing in accordance with the received user's operation, and transmits an image indicating the GUI, which is updated in accordance with the processing, to the wristband type terminal 1.

Note that although the smartphone 2 is used as an example of the external apparatus in the example shown in FIG. 1, the external apparatus according to this embodiment is not limited to this. For example, the external apparatus may be a digital camera, a digital video camera, a personal digital assistant (PDA), a personal computer (PC), a laptop PC, a tablet terminal, a mobile phone terminal, a mobile music reproducing apparatus, a mobile image processing apparatus, a mobile game machine, or the like.

### (Projector 3)

The projector 3 projects an image (still image or moving image) on the plane of projection under control of the control unit 11. In this embodiment, the projector 3 projects an image on a hand (the back of the hand or the palm) wearing the band unit 6, under control of the control unit 11. The projector 3 is achieved by a pico projector using a laser, for example. In this case, since calibration such as focus adjustment is not necessarily performed in principle, the projector 3 can project the image regardless of a position relation between the projector 3 and the plane of projection due to the unevenness of the surface of the hand, the angle of the wrist, and the like.

### (Display Unit 4)

The display unit 4 displays an image (still image or moving image) under control of the control unit 11. The display unit 4 is achieved by a liquid crystal display (LCD), an organic light-emitting diode (OLED), or the like. In this embodiment, the display unit 4 is achieved as a touch panel that is formed integrally with the operation unit 14 which will be described later.

### (Communication Unit 12)

The communication unit 12 exchanges data with the external apparatus. The communication unit 12 communicates with the smartphone 2 by use of a scheme such as wireless communication, Bluetooth (registered trademark), wireless high definition (WiHD), wireless local area network (WLAN), Wireless Fidelity (Wi-Fi, registered trademark), near field communication (NFC), infrared communication, or the like. Alternatively, the communication unit 12 may communicate with the smartphone 2 by use of electric waves of 3G/LTE (long term evolution) or milliwave zone.

In this embodiment, the communication unit 12 functions as a reception unit that receives an image projected by the projector 3 or displayed by the display unit 4, from the smartphone 2 which is associated with the wristband type terminal 1 in advance. More specifically, the communication unit 12 receives an image indicating a GUI of the smartphone 2 as an image projected by the projector 3 or displayed by the display unit 4. Note that the smartphone 2 which is associated with the wristband type terminal 1 can be changed depending on the user's operation, external input, or the like. The communication unit 12 outputs the received image to the control unit 11.

Further, the communication unit 12 is supplied with information indicating the user's operation acquired by the operation unit 14 or the sensor unit 15, which will be described later, from the control unit 11, and transmits the information to the smartphone 2. Thus, the user can operate the smartphone 2 via the wristband type terminal 1.

### (Imaging Unit 13)

The imaging unit 13 includes a lens system including an imaging lens, a stop, a zoom lens, a focus lens, and the like, a drive system that causes a focus operation or a zoom operation of the lens system, a solid-state image sensor array that generates imaging signals by photoelectric conversion of imaging light obtained by the lens system, and the like. The solid-state image sensor array may be achieved by a charge coupled device (CCD) sensor array or a complementary metal oxide semiconductor (CMOS) sensor array. The imaging unit 13 outputs data of the imaged image that is converted into a digital signal, to the control unit 11.

### (Operation Unit 14)

The operation unit 14 has a function of receiving an input from the user (user's operation). For example, the operation unit 14 is achieved by a button, a touch sensor, a trackball, or the like. In this embodiment, the operation unit 14 is achieved by a touch panel that is formed integrally with the display unit 4. The operation unit 14 outputs information indicating the input user's operation to the control unit 11.

### (Sensor Unit 15)

The sensor unit 15 has a function of acquiring operations or states of the user. For example, the sensor unit 15 is achieved by a camera that images the user's face, eye, or hand wearing the wristband type terminal 1. Alternatively, the sensor unit 15 is achieved by a camera having a function of detecting the depth, a microphone, a GPS, an infrared sensor, a ray sensor, a myoelectric sensor, a nerve sensor, a pulse sensor, a thermometer, a gyro sensor, an acceleration sensor, a touch sensor, or the like. Note that the myoelectric sensor, the nerve sensor, the pulse sensor, and the thermometer may be achieved as a bracelet sensor provided on the band unit 6. Since the sensor unit 15 is provided on the main body or the band unit 6, the sensor unit 15 can perform sensing at a position near the hand, and accordingly, the movement of the hand can be acquired more accurately. The sensor unit 15 outputs information indicating the sensing results to the control unit 11.

### (Control Unit 11)

The control unit 11 functions as an arithmetic processing apparatus or a control apparatus, and controls general operations in the wristband type terminal 1 in accordance with various programs. The control unit 11 is achieved by a central processing unit (CPU) or a microprocessor, for example. Note that the control unit 11 may include read only memory (ROM) that stores a program to be used, arithmetic parameters, or the like, and random access memory (RAM) that temporarily stores changing parameters or the like as appropriate.

The control unit 11 controls the projector 3 in a manner that at least one of an image input from the smartphone 2 and an image stored in a storage unit that is not shown is projected on the hand. More specifically, the control unit 11 controls the projector 3 in a manner that an image input from the smartphone 2 via the communication unit 12 is projected on the hand wearing the band unit 6. Further, the control unit 11 may control the projector 3 in a manner that an imaged image received from the smartphone 2, an image indicating a mail text, or the like is temporarily stored in the storage unit that is not shown, and then the image stored in the storage unit is projected. Note that in this embodiment, the control unit 11 controls the projector 3 in a manner that an image input from the smartphone 2 via the communication unit 12 is projected.

Further, in accordance with a user's operation received by the operation unit 14, the control unit 11 controls an image projected by the projector 3. For example, in accordance with a scrolling operation or a zooming in/out operation received by the operation unit 14, the control unit 11 scrolls or zooms in/out an image projected by the projector 3. More specifically, the control unit 11 transmits information indicating the user's operation received by the operation unit 14 to the smartphone 2 via the communication unit 12. The smartphone 2 transmits, to the wristband type terminal 1, an image indicating a GUI that is updated as a result of processing executed in accordance with the received user's operation. Thus, the wristband type terminal 1 projects screen transition in the same manner as in a case in which a flick or a touch is made on a touch panel of the smartphone 2.

In a similar manner, in accordance with a user's operation received by the operation unit 14, the control unit 11 controls an image displayed on the display unit 4. In addition, on the basis of various pieces of information output from the imaging unit 13 and the sensor unit 15, the control unit 11 controls the projector 3 and the display unit 4.

Further, as shown in FIG. 2, the control unit 11 includes functions as a recognition unit 111 and a detection unit 112. The recognition unit 111 and the detection unit 112 enable the wristband type terminal 1 to execute a gesture input.

Recognition Unit 111

The recognition unit 111 includes a function of recognizing the movement of the hand wearing the band unit 6. More specifically, the recognition unit 111 recognizes the movement of the hand through image recognition, motion recognition, or the like using an image obtained by imaging the hand wearing the band unit 6, the image being output from the sensor unit 15. The control unit 11 executes processing such as screen transition on the basis of the results obtained by the recognition by the recognition unit 111.

Detection Unit 112.

The detection unit 112 includes a function of detecting a user's operation on an image projected by the projector 3 on the hand. For example, the detection unit 112 detects a user's operation such as a flick or a touch on the projected image. The control unit 11 transmits information indicating the user's operation detected by the detection unit 112 to the smartphone 2, and then the smartphone 2 executes processing in accordance with the user's operation. Thus, the wristband type terminal 1 displays or projects screen transition in the same manner as in a case in which a flick or a touch is made on a touch panel of the smartphone 2. For example, when the user flicks the projected image in the vertical direction, the projected image is scrolled.

The configuration of the projection system according to this embodiment has been described above. Next, the operation of the projection system according to this embodiment will be described with reference to FIG. 3.

### [2-1-2. Operation Processing]

FIG. 3 is a sequence diagram showing the operation of the projection system according to an embodiment of the present disclosure. As shown in FIG. 3, first, in step S102, it is determined whether or not the smartphone 2 is to be associated with the wristband type terminal 1. For example, it is determined whether the smartphone 2 is set to be operated independently of or in association with the wristband type terminal 1.

In a case where the smartphone 2 is determined to be associated with the wristband type terminal 1 (S102/YES), in step S104, the smartphone 2 transmits image signals to the wristband type terminal 1. More specifically, the smartphone 2 transmits, to the wristband type terminal 1, an image to be projected or displayed by the wristband type terminal 1. Note that in a case where the smartphone 2 is determined to not be associated with the wristband type terminal 1 (S102/NO), the smartphone 2 is operated independently, not in association with the wristband type terminal 1.

Next, in step S106, the wristband type terminal 1 displays the image received from the smartphone 2 on the display unit 4. More specifically, the control unit 11 controls the display unit 4 in a manner that the display unit 4 displays the image received from the smartphone 2 via the communication unit 12.

Next, in step S108, the wristband type terminal 1 determines whether or not the image is projected on the hand. More specifically, the control unit 11 determines whether or not the image is projected on the hand wearing the band unit 6. For example, the control unit 11 determines whether or not the image is projected, by referring to setting information that is set in advance by the user.

In a case where it is determined that the image is to be projected (S108/YES), in step S110, the wristband type terminal 1 projects the image received form the smartphone 2 on the hand by use of the projector 3. More specifically, the control unit 11 controls the projector 3 in a manner that the image received from the smartphone 2 via the communication unit 12 is projected on the hand. Note that in a case where it is determined that the image is to not be projected on the hand (S108/NO), the processing goes back to the step S106.

Next, in step S112, the wristband type terminal 1 determines whether or not the projection ends. For example, in a case where a user's operation that instructs to end the projection is received by the operation unit 14 or the projection is performed for a predetermined period of time, the control unit 11 determines to end the projection.

In a case where the projection is determined to end (S112/YES), in step S114, the wristband type terminal 1 ends the projection of the image by the projector 3. After that, the processing goes back to the step S106, and the wristband type terminal 1 continues to display the image by use of the display unit 4. On the other hand, in a case where the projection is determined to not end (S112/NO), the processing goes back to the step S110, and the projection of the image by the projector 3 is continued.

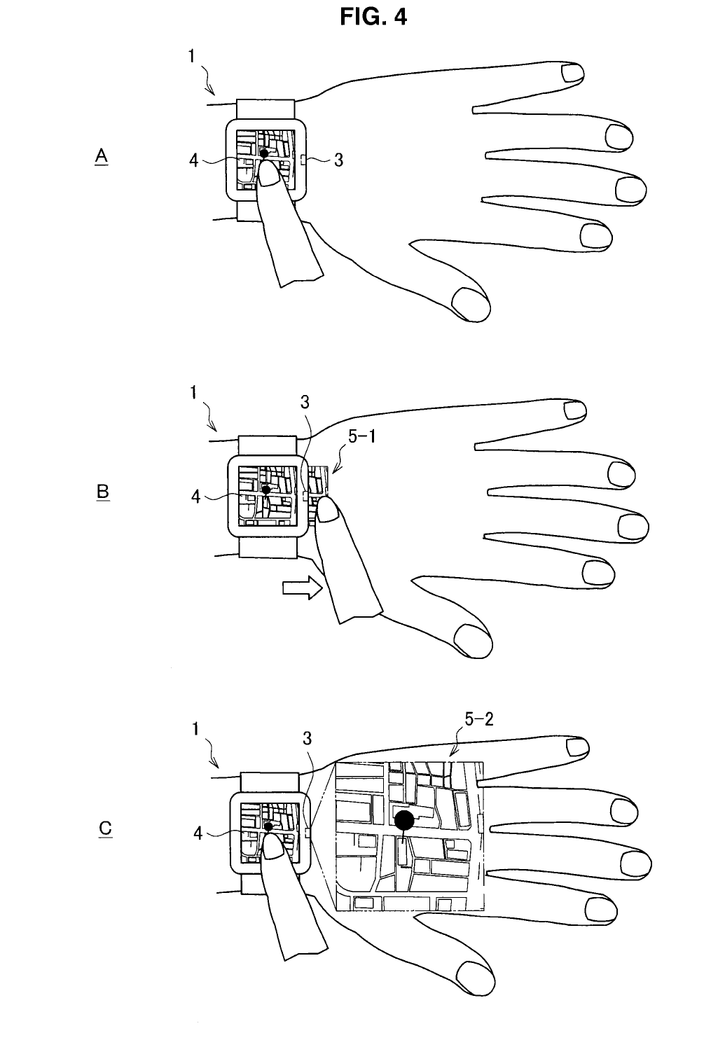

The configuration and operation processing of the projection system, which are common to embodiments of the present disclosure, have been described above. Next, embodiments of the present disclosure will be described in detail with reference to FIGS. 4A to 4C to FIG. 14.

### 2-2. First Embodiment

In this embodiment, in accordance with a user's operation on the wristband type terminal 1, an image displayed on the display unit 4 is projected on a hand by the projector 3. This embodiment will be described in detail below with reference to FIGS. 4A to 4C.

FIGS. 4A to 4C are explanatory drawings showing projection processing according to the first embodiment. As shown in FIG. 4A, the display unit 4 displays an image showing a map. In this embodiment, the control unit 11 controls the projector 3 in a manner that the image displayed on the display unit 4 is projected on the hand in accordance with a user's operation received by the operation unit 14. For example, in order to zoom in the image, the user drags the image displayed on the display unit 4 with a finger and drops the image on the palm or the back of the hand as shown in FIG. 4B. At this time, the wristband type terminal 1 detects the drag operation on the display unit 4 by use of the operation unit 14 formed integrally with the display unit 4 as a touch panel, and further detects the drag operation or the drop operation on the palm or the back of the hand with a camera, an infrared sensor, or the like included in the sensor unit 15. Accordingly, as shown in FIG. 4C, the wristband type terminal 1 projects a projected image 5-2, in which the image displayed on the display unit 4 is zoomed in, on the hand by the projector 3.

Note that as shown in FIG. 4B, while the user's finger is dragging on the palm or the back of the hand, the wristband type terminal 1 may project a projected image 5-1 indicating the dragging on the position of the finger. Further, the wristband type terminal 1 may project a zoomed in image on the hand on the basis of a simple flick operation made on the touch panel.

In this manner, the wristband type terminal 1 according to this embodiment can project a zoomed in image easily by dragging and dropping. Further, as shown in FIG. 4C, the user can stroll the map by making a flick operation on the display unit 4 (touch panel). In addition, the user can zoom in the map on the basis of an operation of opening two fingers touching the display unit 4, or can zoom out the map on the basis of an operation of closing the two fingers.

The first embodiment has been described above.

### 2-3. Second Embodiment

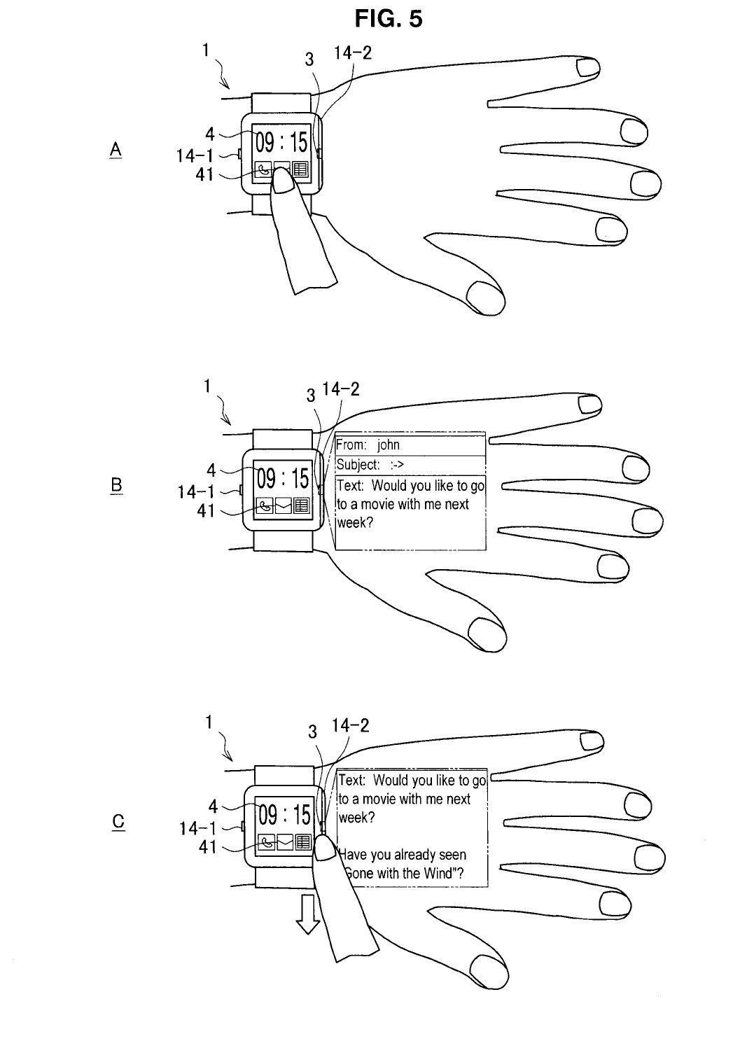

In this embodiment, different images are projected or displayed by the projector 3 and the display unit 4, and also independent operations are possible with respect to the respective image. This embodiment will be described in detail below with reference to FIGS. 5A to 5C.

FIGS. 5A to 5C are explanatory drawings showing projection processing according to the second embodiment. As shown in FIG. 5A, a basic screen (home screen) of the wristband type terminal 1 including a plurality of application icons is displayed on the display unit 4 (touch panel). In this embodiment, the control unit 11 controls the projector 3 in a manner that an image that is different from the image displayed on the display unit 4 is projected on the hand, in accordance with a user's operation received by the operation unit 14. For example, when the user touches a mail icon 41, as shown in FIG. 5B, the wristband type terminal 1 projects a mail text on the hand by use of the projector 3 while keeping the display of the home screen on the display unit 4. Accordingly, while reading the mail text, the user can check reception of new mail on the home screen displayed on the display unit 4 or check mail that the user has sent previously on the display unit 4.

Here, as shown in FIG. 5C, the wristband type terminal 1 according to this embodiment is provided with a button 14-1 and a touch sensor 14-2. As shown in FIG. 5C, the user can scroll the mail text projected on the hand by operating the touch sensor 14-2. Further, the user can scroll the display on the display unit 4, for example, by touching directly the display unit 4. In this manner, by providing the touch sensor 14-2 additionally, the wristband type terminal 1 enables separate operations of the image displayed on the display unit 4 and the image projected by the projector 3.

Further, the wristband type terminal 1 switches whether a touch input to the display unit 4 is regarded as an operation with respect to the image displayed on the display unit 4 or an operation with respect to the image projected by the projector 3, by use of the button 14-1. While switching operation targets by use of the button 14-1, the user can scroll or zoom in/out the image displayed on the display unit 4 and the image projected by the projector 3 separately, for example.

The second embodiment has been described above.

### 2-4. Third Embodiment

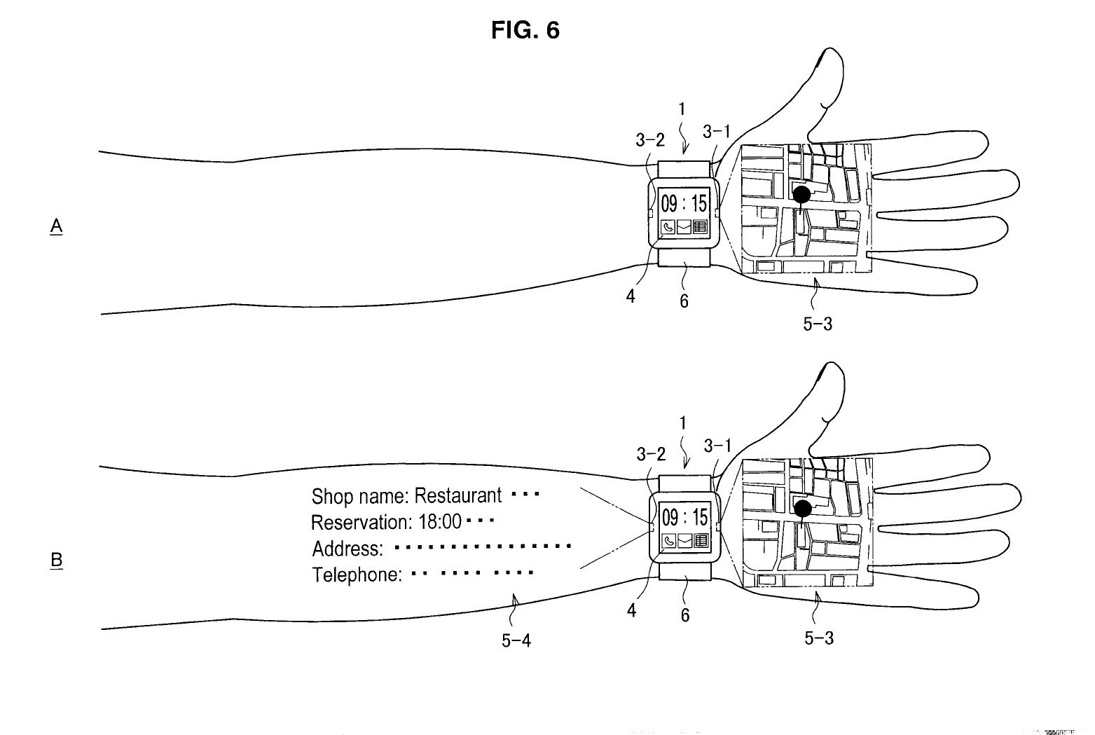

In this embodiment, two projectors 3 are included. This embodiment will be described in detail below with reference to FIGS. 6A and 6B.

FIGS. 6A and 6B are explanatory drawings showing projection processing according to the third embodiment. As shown in FIG. 6A, the user checks a projected map 5-3 by projecting, by use of a projector 3-1, a zoomed in map including a shop that the user is visiting for the first time. Here, as shown in FIG. 6A, the wristband type terminal 1 according to this embodiment includes, in addition to the projector 3-1 which projects the image on the hand, a projector 3-2 (another projection unit) which projects an image on a forearm portion wearing the band unit 6. As shown in FIG. 6B, the projectors 3-1 and 3-2 are capable of projecting zoomed in images which are different from each other. More specifically, the control unit 11 controls the projector 3-1 in a manner that a first image is projected on the hand and the projector 3-2 in a manner that a second image is projected on the forearm portion. Accordingly, the wristband type terminal 1 is capable of displaying three images at a time, by taking the display unit 4 into consideration. Further, since the three images are displayed to be adjacent to one another, the user can see each image without moving the eyes largely. For example, as shown in FIG. 6B, while causing the projector 3-1 to project the map (first image) 5-3 of the shop that the user is visiting for the first time, the user can check a reservation time and the like by causing the projector 3-2 to project mail (second image) 5-4 by which the reservation has been made.

Note that the wristband type terminal 1 according to this embodiment enables operations similar to those described in the first and second embodiments. That is, the user can operate the images projected by the projectors 3-1 and 3-2 and the image displayed by the display unit 4 separately through a touch input or sensing of the sensor unit 15, which is not shown. Further, the user may exchange the image projected by the projector 3-1 for the image projected by the projector 3-2 by dragging and dropping.

The third embodiment has been described above.

### 2-5. Fourth Embodiment

The smartphone 2 may incorporate a tuner that receives an image externally from broadcasting waves such as terrestrial broadcasting waves or satellite broadcasting waves. Accordingly, the wristband type terminal 1 according to this embodiment projects an image from broadcasting waves by use of the projector 3 and also displays program information and the like by use of the display unit 4.

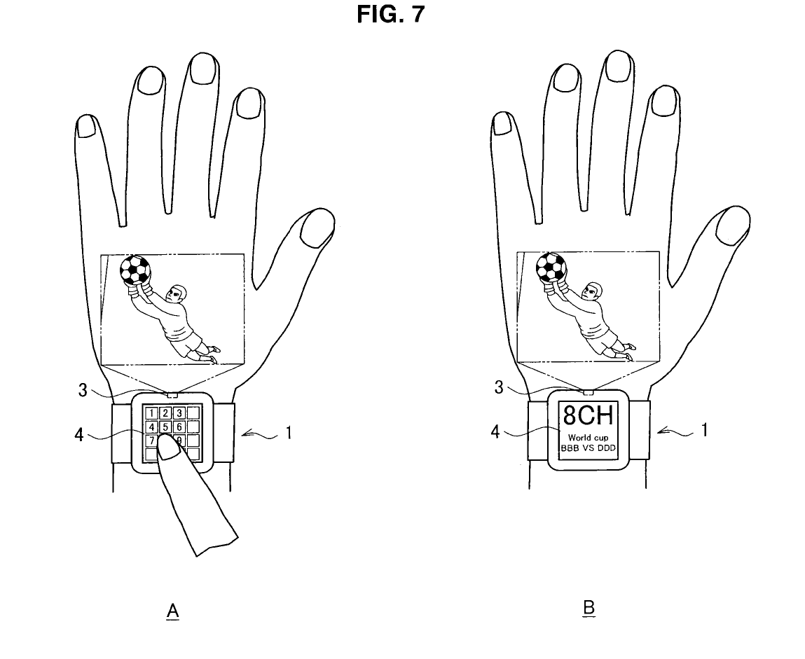

More specifically, in this embodiment, the control unit 11 controls the projector 3 in a manner that an image from broadcasting waves such as terrestrial broadcasting waves or satellite broadcasting waves, which are input externally, is projected on the hand. Further, the control unit 11 controls the display unit 4 in a manner that related information such as subtitles and program information, which relates to the broadcasting waves being projected by the projector 3, is displayed. This embodiment will be described below with reference to FIGS. 7A and 7B.

FIGS. 7A and 7B are explanatory drawings showing projection processing according to the fourth embodiment. As shown in FIG. 7A, the wristband type terminal 1 according to this embodiment projects an image on the hand by the projector 3, the image being received by use of a one-segment tuner or a full-segment tuner built in the smartphone 2. Note that the wristband type terminal 1 may include a speaker that is not shown to output the sound of television. Further, the user can change viewing channels by selecting channels displayed on the display unit 4 through a touch input.

Further, as shown in FIG. 7B, the wristband type terminal 1 displays subtitles, channel information, program information, and the like on the display unit 4. In general, in a case where a television moving image is displayed on a screen of the smartphone 2, subtitles, channel information, and program information are displayed in a lower part of the screen, so that the display of the television moving image is small. In contrast, in this embodiment, the display unit 4 displays subtitles, channel information, and program information, and the projector 3 projects the television moving image on the entire plane of projection; accordingly, the user can view the image without making the television moving image small. Further, the wristband type terminal 1 may include a vibration unit that vibrates the wristband type terminal 1, and the vibration unit may vibrate depending on the television moving image. In this case, vibration travels to the user and the projected image itself projected by the projector 3 vibrates, resulting in a more powerful image.

The fourth embodiment has been described above.

### 2-6. Fifth Embodiment

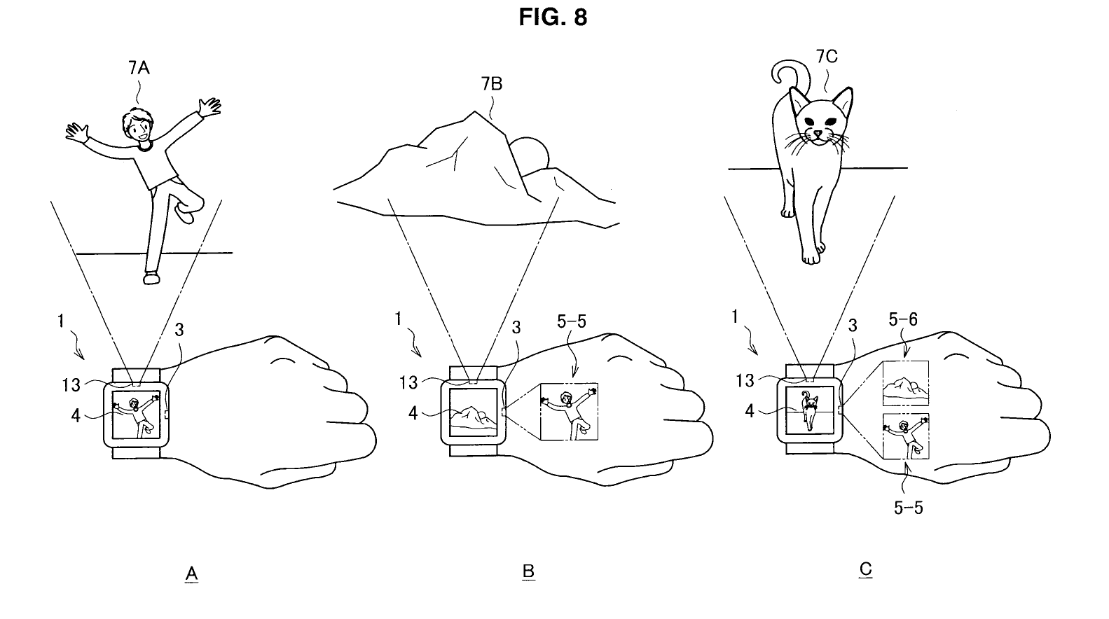

In this embodiment, when imaging, a through image is displayed on the display unit 4 and an imaged image is projected by the projector 3. This embodiment will be described in detail below with reference to FIGS. 8A to 8C.

FIGS. 8A to 8C are explanatory drawings showing projection processing according to the fifth embodiment. As shown in FIG. 8A, the user is about to image a subject 7A by use of the imaging unit 13. At this time, the control unit 11 controls the display unit 4 in a manner that a through image of the subject 7A taken by the imaging unit 13 is displayed, and the through image of the subject 7A is displayed on the display unit 4 as shown in FIG. 8A. Accordingly, the user can perform imaging while checking the position, focus, and the like of the subject 7A by use of the display unit 4.

When the imaging is performed, the control unit 11 controls the projector 3 in a manner that the image imaged by the imaging unit 13 is projected on the hand. More specifically, as shown in FIG. 8B, the projector 3 projects a projected image 5-5 of the imaged subject 7A. At this time, the display unit 4 displays the through image of the subject 7B taken by the imaging unit 13. Accordingly, the user can perform imaging while checking the previously imaged image and the current through image of the imaging target at the same time.

Further, the control unit 11 may control the projector 3 in a manner that a plurality of images imaged by the imaging unit 13 are projected on the hand. More specifically, as shown in FIG. 8C, the projector 3 may project a projected image 5-6 showing an imaged subject 7B and the projected image 5-5 showing the imaged subject 7A, which has been taken the last time, side by side on the hand. In this manner, since the wristband type terminal 1 projects the imaged images in order on the hand, the user can perform the next imaging while checking the photographs that have been taken a while ago.

The fifth embodiment has been described above.

### 2-7. Sixth Embodiment

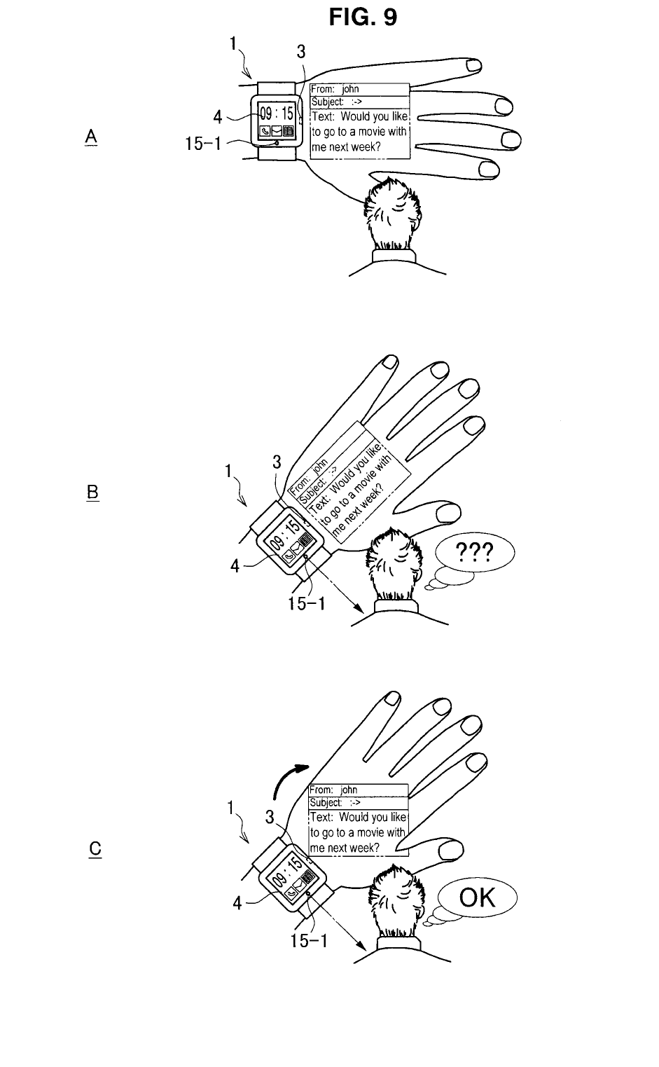

In this embodiment, the projection is performed by adjusting a display angle in a manner that the image is recognized easily in accordance with a relative position relation between the user's eyes and hand. This embodiment will be described in detail below with reference to FIGS. 9A to 9C.

FIGS. 9A to 9C are explanatory drawings showing projection processing according to the sixth embodiment. As shown in FIG. 9A, the user is viewing a mail text by use of the projector 3. Here, since the user wears the wristband type terminal 1 on the wrist, depending on the state such as the angle or height of the hand, the text is not parallel with the user's eyes and is oblique in some cases. For example, as shown in FIG. 9B, in a case where the user's hand is in an oblique direction, the text is also in the oblique direction, which is difficult to read.

Accordingly, in this embodiment, the control unit 11 controls the display angle of the image projected by the projector 3 in accordance with a relative position relation between the user's eyes and hand obtained by the sensor unit 15. More specifically, first, the control unit 11 specifies the position of the user's eyes by use of a camera or an infrared camera (denoted by a reference numeral 15-1 in FIGS. 9A to 9C), and the position and angle of the user's arm are specified by a gyro sensor or an acceleration sensor, thereby calculating the relative position relation between the user's eyes and hand. Then, the control unit 11 corrects the display angle of the image in a manner that the text can be parallel with the user's eyes in accordance with the calculated position relation.

The correction of the display angle in this manner enables the projector 3 to project the text in parallel with the user's eyes as shown in FIG. 9C. Thus, the user can read the text without feeling difficulty in reading. Note that the position at which the wristband type terminal 1 is worn differs depending on the user, whether the left hand or the right hand or whether high or low, for example. Therefore, the control unit 11 corrects the display angle in a range of 0° to 360°.

Note that this embodiment shows the example in which the text is corrected to be parallel with the user's eyes; however, this embodiment is not limited to this example. For example, the control unit 11 may correct the display angle in a manner that the image is not projected in the oblique direction with respect to the user's eyes, the image being any image such as a landscape image or a portrait.

The sixth embodiment has been described above.

### 2-8. Seventh Embodiment

In this embodiment, the direction of projection by the projector 3 is controlled in accordance with the movement of the hand wearing the wristband type terminal 1. For example, the wristband type terminal 1 is usually operated in a close-projection mode in which the image is projected on the back of the hand, and is operated in a distant-projection mode in which the image is projected to a distant area, not on the back of the hand, in a case where the hand makes a predetermined movement.

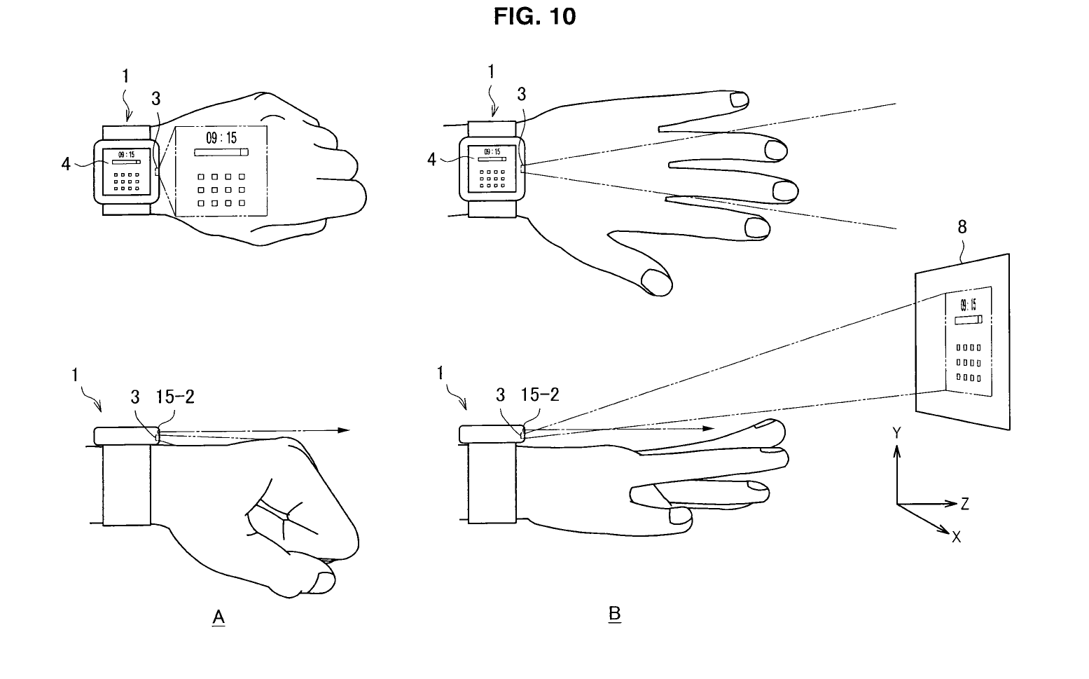

In this embodiment, first, the recognition unit 111 recognizes the movement of the hand on the basis of the sensing results by the sensor unit 15. Then, the control unit 11 controls the direction of projection by the projector 3 in accordance with the hand's movement recognized by the recognition unit 111. This embodiment will be described in detail below with reference to FIGS. 10A and 10B.

FIGS. 10A and 10B are explanatory drawings showing projection processing according to the seventh embodiment. More specifically, FIG. 10A is an explanatory drawing showing the operation in the close-projection mode and FIG. 10B is an explanatory drawing showing the operation in the distant-projection mode.

As shown in FIG. 10A, since a camera or an infrared sensor (denoted by a reference numeral 15-2 in FIG. 10A) fails to detect a finger, the recognition unit 111 recognizes that the user is grasping the hand. In this case, since the user is grasping the hand, the control unit 11 directs the direction of projection by the projector 3 on the back of the hand. Thus, the projector 3 projects the image in a close area of the wristband type terminal 1, that is, on the back of the hand wearing the wristband type terminal 1. Note that in this embodiment, as shown in FIG. 10A, the display unit 4 and the projector 3 display or project a home image of the associated smartphone 2.

In contrast, since the camera or the infrared sensor (denoted by the reference numeral 15-2 in FIG. 10B) detects a finger, as shown in FIG. 10B, the recognition unit 111 recognizes that the user is releasing the hand. In this case, since the user is releasing the hand, the control unit 11 moves the direction of projection by the projector 3 to a direction (Y direction) that is separated away from the back of the hand in a manner that the image is not to be projected on the back of the hand. Thus, the projector 3 can project the image on a distant screen 8, a wall, a floor, or the like, other than the hand wearing the wristband type terminal 1. Note that in a case where the projector 3 is achieved by a projector using a laser, the projector 3 can project the image on the distant screen 8 or the like without performing calibration such as focus adjustment in principle. It is needless to say that the projector 3 may automatically perform calibration on the basis of a projection distance or the like.

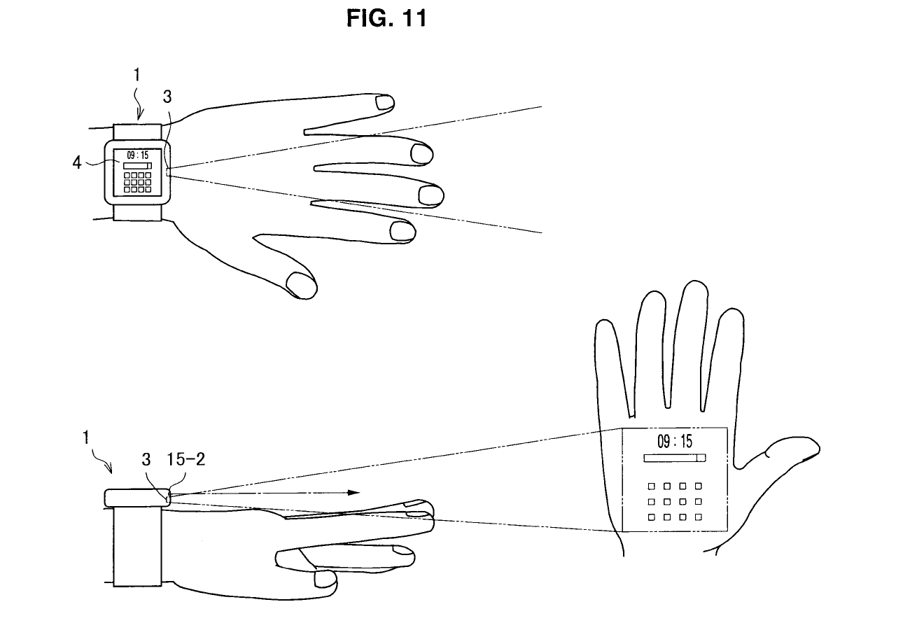

Further, as shown in FIG. 11, the projector 3 may project the image on the other hand that does not wear the wristband type terminal 1, instead of the distant area. FIG. 11 is an explanatory drawing showing projection processing according to the seventh embodiment. As shown in FIG. 11, since the camera or the infrared sensor (denoted by the reference numeral 15-2 in FIG. 11) detects a finger, the recognition unit 111 recognizes that the user is releasing the hand. In this case, the control unit 11 moves the direction of projection by the projector 3 in the direction (Y direction) separating apart from the back of the hand in a manner that the image is not projected on the back of the hand. At this time, in a case where the other hand not wearing the wristband type terminal 1 is in the direction of projection by the projector 3, the image is projected on the other hand.

The seventh embodiment has been described above.

### 2-9. Eighth Embodiment

In this embodiment, the smartphone 2 is operated in accordance with the movement of the hand wearing the wristband type terminal 1. More specifically, the wristband type terminal 1 according to this embodiment recognizes a gesture input made by the hand wearing the wristband type terminal 1, and projects an image that is updated by the smartphone 2 in accordance with processing based on the gesture input.

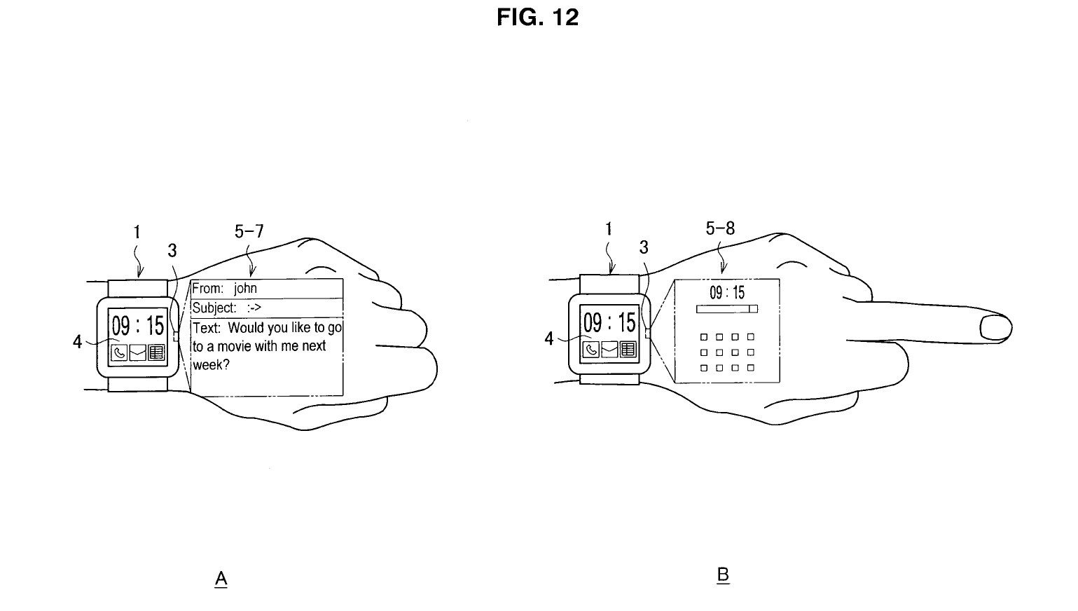

In this embodiment, first, the recognition unit 111 recognizes the hand's movement on the basis of the sensing results by a camera or an infrared sensor included in the sensor unit 15. Alternatively, the recognition unit 111 may recognize the hand's movement on the basis of electric signals of myoelectricity or a nerve detected by a myoelectric sensor or a nerve sensor included in the sensor unit 15. Then, the control unit 11 controls an image projected by the projector 3 in accordance with the hand's movement recognized by the recognition unit 111. This embodiment will be described in detail below with reference to FIGS. 12A and 12B.

FIGS. 12A and 12B are explanatory drawings showing projection processing according to the eighth embodiment. As shown in FIG. 12A, the projector 3 projects a projected image 5-7 indicating a mail text on the back of the hand. In this embodiment, the wristband type terminal 1 allocates a frequently used key to each finger of the hand wearing the wristband type terminal 1, and operation of the smartphone 2 in accordance with the finger's movement controls the image projected by the projector 3.

For example, the wristband type terminal 1 allocates, to a thumb, a start key that instructs the start of the imaging unit 13 and a shutter key that instructs imaging by the imaging unit 13. In a similar manner, the wristband type terminal 1 allocates a back key that instructs cancellation of operation to a forefinger, a home key that instructs the display of the home screen to a middle finger, a menu key that instructs the display of a menu to a ring finger, and a key that instructs ON/OFF of the projection by the projector 3 to a little finger. This allocation may also be set freely by the user.

When the user wants to go back to the home screen while using the projector 3, the user moves the middle finger by stretching or folding the middle finger. Then, the recognition unit 111 recognizes the movement of the middle finger, and on the basis of the recognition results, the control unit 11 controls the projector 3 in a manner that the home screen of the smartphone 2 is projected. Thus, as shown in FIG. 12B, a projected image 5-8 indicating the home screen is projected by the projector 3.

The eighth embodiment has been described above.

### 2-10. Ninth Embodiment

In this embodiment, in accordance with a user's operation on a projected image projected by the projector 3, the smartphone 2 is operated. More specifically, the wristband type terminal 1 according to this embodiment detects a user's operation such as a touch or a flick input made on the projected image, and projects an image that is updated by the smartphone 2 in accordance with processing based on the user's operation.

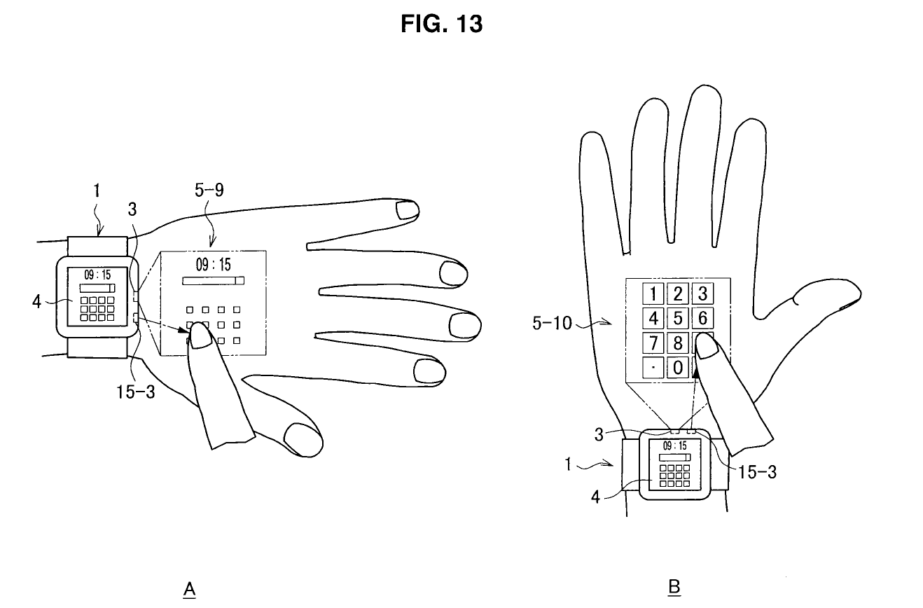

In this embodiment, first, the detection unit 112 detects a user's operation on an image projected by the projector 3 on the hand, on the basis of sensing results by a camera or an infrared sensor having a function of detecting the depth, the camera or the infrared sensor being included in the sensor unit 15. Then, the control unit 11 controls the image projected by the projector 3 in accordance with the user's operation detected by the detection unit 112. This embodiment will be described in detail below with reference to FIGS. 13A and 13B.

FIGS. 13A and 13B are explanatory drawings showing projection processing according to the ninth embodiment. As shown in FIG. 13A, the wristband type terminal 1 includes a camera 15-3 having a function of detecting the depth, and projects a projected image 5-9 indicating the home screen. On the basis of an image imaged by the camera 15-3 having the function of detecting the depth, the detection unit 112 detects a user's touch on an icon included in the home screen projected by the projector 3. Then, the control unit 11 controls the projector 3 in a manner that a screen corresponding to the touched icon is projected. For example, in a case where a mail icon is touched, the control unit 11 receives a mail text from the smartphone 2 via the communication unit 12 and causes the projector 3 to project the mail text.

In addition, the wristband type terminal 1 can zoom in an image on the basis of an operation of opening two fingers touching a projected image, zoom out an image on the basis of an operation of closing two fingers, or scroll an image on the basis of a flick operation. Further, the wristband type terminal 1 may move the icon or the like in the projected image, for example, in accordance with a dragging and dropping operation made on the projected image. Furthermore, as shown in FIG. 13B, the wristband type terminal 1 according to this embodiment may operate the smartphone 2 in accordance with a user's operation made on a projected image 5-10 indicating a screen of selecting numbers, for example, other than the home screen.

The ninth embodiment has been described above.

### 2-11. Tenth Embodiment

In this embodiment, a wristband type terminal 10 includes a function as the smartphone 2. That is, the wristband type terminal 10 according to this embodiment can, for example, transmit or receive mail or enables viewing thereof independently, not in association with the smartphone 2. A configuration of the wristband type terminal 10 according to this embodiment will be described below.

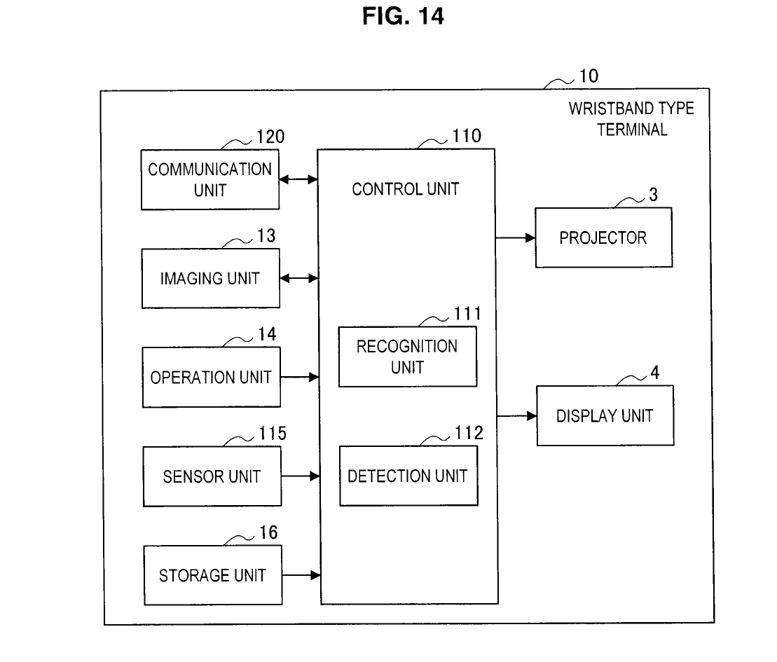

FIG. 14 is a block diagram showing the configuration of the wristband type terminal 10 according to the tenth embodiment. As shown in FIG. 14, the wristband type terminal 10 includes the projector 3, the display unit 4, the imaging unit 13, the operation unit 14, the sensor unit 15, a storage unit 16, and a control unit 110, and a communication unit 120.

### (Storage Unit 16)

The storage unit 16 is a part that performs recording and reproduction of data of a predetermined recording medium. The storage unit 16 is achieved as a hard disc drive (HDD), for example. It is needless to say that the recording medium can be any of the following various media: a solid-state memory such as a flash memory, a memory card incorporating a fixing memory, an optical disc, a magneto-optical disc, a hologram memory, and the like. The storage unit 16 is configured so as to execute recording and reproduction in accordance with an employed recording medium.

The storage unit 16 according to this embodiment stores a variety of application programs, resource data such as images and sounds, mail data, and the like, which cause the wristband type terminal 10 to function as the smartphone 2.

### (Communication Unit 120)

The communication unit 120 exchanges data with an external apparatus. The communication unit 120 performs communication by use of wireless communication, Bluetooth (registered trademark), WiHD, WLAN, Wi-Fi, (registered trademark), NFC, infrared communication, or electric waves of 3G/LTE or milliwave zone. For example, the communication unit 120 according to this embodiment transmits mail created by the user or receives Web content.

### (Control Unit 110)

The control unit 111 functions as an arithmetic processing apparatus or a control apparatus, and controls general operations in the wristband type terminal 10 in accordance with various programs. The control unit 110 is achieved by a CPU or a microprocessor, for example. Note that the control unit 110 may include ROM that stores a program to be used, arithmetic parameters, or the like, and RAM that temporarily stores changing parameters or the like as appropriate.

In this embodiment, the control unit 110 controls the projector 3 in a manner that an image stored in the storage unit 16 is projected on the hand wearing the band unit 6. For example, the control unit 110 controls the projector 3 in a manner that a mail text stored in the storage unit 16 is projected. Further, the control unit 110 may control the projector 3 in a manner that an image input from the external apparatus is projected. For example, the control unit 110 controls the projector 3 in a manner that Web content received externally from a server or the like via the communication unit 120 is projected. In addition, the control unit 110 includes functions similar to those of the control unit 11 described above in the basic form.

The configuration of wristband type terminal 10 according to this embodiment has been described above. Note that the projector 3, the display unit 4, the imaging unit 13, the operation unit 14, and the sensor unit 15 are the same as those described above in the basic form with reference to FIG. 2; therefore, a detailed description thereof is omitted here. Further, operation processing in this embodiment is the same as that described above in the basic form with reference to FIG. 3, except that the wristband type terminal 10 is operated independently; therefore, a detailed description thereof is omitted here.

### 3. CONCLUSION

As described above, a wristband type terminal according to an embodiment of the present disclosure can increase the usability of a mobile terminal. More specifically, the wristband type terminal 1 is associated with the smartphone 2 in order to function as an output device and an input device thereof, so that the user can view a map, Web, mail, and the like without taking the smartphone 2 on the hand.

Although the preferred embodiments of the present disclosure have been described in detail with reference to the appended drawings, the present disclosure is not limited thereto. It should be understood by those skilled in the art that various modifications, combinations, sub-combinations and alterations may occur depending on design requirements and other factors insofar as they are within the scope of the appended claims or the equivalents thereof.

For example, it is possible to create a computer program for causing hardware such as CPU, ROM, or RAM, incorporated in an information processing apparatus, to have the same functions as each structural component of the wristband type terminal 1 or the wristband type terminal 10. Further, it is also possible to provide a storage medium storing the computer program.

The effects described in the specification are just explanatory or exemplary effects, and are not limiting. That is, the technology according to the present disclosure can exhibit other effects that are apparent to a person skilled in the art from the descriptions in the specification, along with the above effects or instead of the above effects.

Additionally, the present technology may also be configured as below.

(1)

A wristband type information processing apparatus including:

a band unit configured to be worn on a wrist of a user;

a projection unit configured to project an image on a hand wearing the band unit; and

a control unit configured to control the projection unit in a manner that at least one of an image that is stored in a storage unit and an image that is input from an external apparatus is projected on the hand.

(2)

The wristband type information processing apparatus according to (1), further including:

an operation unit configured to receive a user's operation,

wherein the control unit controls an image projected by the projection unit in accordance with the user's operation that has been received by the operation unit.

(3)

The wristband type information processing apparatus according to (2), further including:

a display unit,

wherein the control unit controls the projection unit in a manner that an image displayed on the display unit is projected on the hand in accordance with the user's operation that has been received by the operation unit.

(4)

The wristband type information processing apparatus according to (2), further including:

a display unit,

wherein the control unit controls the projection unit in a manner that an image different from an image displayed on the display unit is projected on the hand in accordance with the user's operation that has been received by the operation unit.

(5)

The wristband type information processing apparatus according to any one of (1) to (4), further including:

a detection unit configured to detect a user's operation on an image projected by the projection unit on the hand,

wherein the control unit controls the image projected by the projection unit in accordance with the user's operation detected by the detection unit.

(6)

The wristband type information processing apparatus according to (4), wherein the control unit controls the projection unit in a manner that an image from broadcasting waves that are externally input is projected on the hand, and controls the display unit in a manner that related information that relates to the broadcasting waves is displayed.

(7)

The wristband type information processing apparatus according to (4), further including:

an imaging unit,

wherein the control unit controls the projection unit in a manner that an image imaged by the imaging unit is projected on the hand, and controls the display unit in a manner that a through image taken by the imaging unit is displayed.

(8)

The wristband type information processing apparatus according to any one of (1) to (7), further including:

another projection unit configured to project an image on a forearm portion wearing the band unit.

(9)

The wristband type information processing apparatus according to (8), wherein the control unit controls the projection unit in a manner that a first image is projected on the hand, and controls the another projection unit in a manner that a second image is projected on the forearm portion.

(10)

The wristband type information processing apparatus according to any one of (1) to (9), wherein the control unit controls a display angle of an image projected by the projection unit in accordance with a relative position relation between an eye and the hand of the user.

(11)

The wristband type information processing apparatus according to any one of (1) to (10), further including:

a recognition unit configured to recognize movement of the hand.

(12)

The wristband type information processing apparatus according to (11), wherein the control unit controls a direction of projection by the projection unit in accordance with the movement of the hand recognized by the recognition unit.

(13)

The wristband type information processing apparatus according to (11) or (12), wherein the control unit controls an image projected by the projection unit in accordance with the movement of the hand recognized by the recognition unit.

(14)

The wristband type information processing apparatus according to any one of (1) to (13), further including:

a reception unit configured to receive an image projected by the projection unit from a mobile terminal that is associated with the wristband type information processing apparatus.

(15)

The wristband type information processing apparatus according to (14), wherein the reception unit receives an image indicating a graphical user interface of the mobile terminal as the image projected by the projection unit.

(16)

The wristband type information processing apparatus according to any one of (1) to (15), wherein the projection unit is a pico projector using a laser.

(17)

A non-transitory computer-readable storage medium having a program stored therein, the program for causing a computer to function as:

a projection unit configured to project an image on a hand wearing a band unit; and

a control unit configured to control the projection unit in a manner that at least one of an image stored in a storage unit and an image input from an external apparatus is projected on the hand.

What is claimed is:

1. A wristband type information processing apparatus comprising:
a band unit configured to be worn on a wrist of a user;
a projection unit configured to project an image on a hand wearing the band unit; and
a control unit configured to control the projection unit in a manner that at least one of an image that is stored in a storage unit and an image that is input from an external apparatus is projected on the hand.

2. The wristband type information processing apparatus according to claim 1, further comprising:
an operation unit configured to receive a user's operation,
wherein the control unit controls an image projected by the projection unit in accordance with the user's operation that has been received by the operation unit.

3. The wristband type information processing apparatus according to claim 2, further comprising:
a display unit,
wherein the control unit controls the projection unit in a manner that an image displayed on the display unit is projected on the hand in accordance with the user's operation that has been received by the operation unit.

4. The wristband type information processing apparatus according to claim 2, further comprising:
a display unit,
wherein the control unit controls the projection unit in a manner that an image different from an image displayed on the display unit is projected on the hand in accordance with the user's operation that has been received by the operation unit.

5. The wristband type information processing apparatus according to claim 1, further comprising:
a detection unit configured to detect a user's operation on an image projected by the projection unit on the hand,
wherein the control unit controls the image projected by the projection unit in accordance with the user's operation detected by the detection unit.

6. The wristband type information processing apparatus according to claim 4, wherein the control unit controls the projection unit in a manner that an image from broadcasting waves that are externally input is projected on the hand, and controls the display unit in a manner that related information that relates to the broadcasting waves is displayed.

7. The wristband type information processing apparatus according to claim 4, further comprising:
an imaging unit,
wherein the control unit controls the projection unit in a manner that an image imaged by the imaging unit is projected on the hand, and controls the display unit in a manner that a through image taken by the imaging unit is displayed.

8. The wristband type information processing apparatus according to claim 1, further comprising:
another projection unit configured to project an image on a forearm portion wearing the band unit.

9. The wristband type information processing apparatus according to claim 8, wherein the control unit controls the projection unit in a manner that a first image is projected on the hand, and controls the another projection unit in a manner that a second image is projected on the forearm portion.

10. The wristband type information processing apparatus according to claim 1, wherein the control unit controls a display angle of an image projected by the projection unit in accordance with a relative position relation between an eye and the hand of the user.

11. The wristband type information processing apparatus according to claim 1, further comprising:
a recognition unit configured to recognize movement of the hand.

12. The wristband type information processing apparatus according to claim 11, wherein the control unit controls a direction of projection by the projection unit in accordance with the movement of the hand recognized by the recognition unit.

13. The wristband type information processing apparatus according to claim 11, wherein the control unit controls an image projected by the projection unit in accordance with the movement of the hand recognized by the recognition unit.

14. The wristband type information processing apparatus according to claim 1, further comprising:
a reception unit configured to receive an image projected by the projection unit from a mobile terminal that is associated with the wristband type information processing apparatus.

15. The wristband type information processing apparatus according to claim 14, wherein the reception unit receives an image indicating a graphical user interface of the mobile terminal as the image projected by the projection unit.

16. The wristband type information processing apparatus according to claim 1, wherein the projection unit is a pico projector using a laser.

17. A non-transitory computer-readable storage medium having a program stored therein, the program for causing a computer to function as:
a projection unit configured to project an image on a hand wearing a band unit; and
a control unit configured to control the projection unit in a manner that at least one of an image stored in a storage unit and an image input from an external apparatus is projected on the hand.
